(19) United States
(12) Patent Application Publication
(10) Pub. No.: US 2014/0267188 A1
(43) Pub. Date: Sep. 18, 2014

(54) COMBINED TOUCH PEN FOR SMARTPHONES

(71) Applicant: WERNER DORSCH, Dieburg (DE)

(72) Inventor: Andreas SCHWARZ, Gross-Bieberau (DE)

(73) Assignee: WERNER DORSCH, Dieburg (DE)

(21) Appl. No.: 14/027,205

(22) Filed: Sep. 15, 2013

(30) Foreign Application Priority Data
Mar. 12, 2013 (DE) 20 2013 002 342.2

(51) Int. Cl. G06F 3/033

(52) U.S. Cl. CPC G06F 3/033
USPC 345/179

(57) ABSTRACT

In a combined touch pen for touching touch-sensitive screens of smart phones or similar apparatus, comprising a touch pen part and a support leg part, wherein the touch pen part is provided at its front end with a touch tip, the support leg part is provided at one end with a plug which is attached to the support leg part end via a hinge joint, and the plug is insertable into an ear phone receptacle of the smart phone or another opening provided therein, and the touch pen part and the support leg part are axially insertable into one another to form a uniform body, as one of the two parts is in the form of a sleeve body in which the other part is at least partially accommodated.

### BACKGROUND OF THE INVENTION

The invention resides in a combined touch pen for touch-sensitive screens of smart phones or similar apparatus.

As it is well-known, a touch pen is a pen for contacting small touch-sensitive surfaces for example of a key pad displayed on the touch-sensitive screen of a smart phone. The contact tip may be in the form of a rubber tip or plastic tip or a rounded metal tip to permit contacting the screen without damaging it.

Such touch pens are known. Also, touch pens are known at whose back end via a flexible cord a plug is attached which can be inserted into an earphone socket of a smart phone so that the touch pen is attached to the smart phone and does not need, to be held in the hand and cannot drop to the floor. The cord is long enough so that the touch pen can be used with the plug inserted.

In connection with touch pens, it is also known to arrange such a plug via a joint directly at the rear end of the touch pen. In this way, a second function, that is a support function, can be assigned to the touch pen if the plug is inserted at the upper edge of the smart phone. The smart phone can then be placed on a table or another surface at an angle that, makes the screen more convenient to read for example news or internet contents. Then, however the touch pen is no longer available in its function as a touch pen.

It is the object of the present invention to provide a touch pen which is more versatile and more practical with regard to its functionality.

### SUMMARY OF THE INVENTION

In a combined touch, pen for touching touch-sensitive screens of smart phones or similar apparatus, comprising a touch pen part and a support leg part, wherein the touch pen part is provided at its front end with a touch tip, the support leg part is provided at one end with a plug which is attached, to the support leg part end via a hinge joint, and the plug is insertable into an ear phone receptacle of the smart phone or another opening provided therein. The and touch pen part and the support leg part are axially insertable into one another to form a uniform body, as one of the two parts is in the form of a sleeve body in which the other part is at least partially accommodated.

The support leg part is preferably formed telescope-like so that its length and, accordingly, the inclination of the smart phone supported thereby is adjustable. The telescope elements of the support leg cooperate by frictional connection in such a way that the relative adjustment that is the length change is frictionally impeded so that the position adjusted for a particular use remains stable during the support of the smart phone.

The support leg part may be provided at its end opposite the plug with a slide impeding cap. The cap is preferably so designed that it can also be used as a touch tip so that, with the support leg part and the touch pen part inserted into one another, both ends of the combined touch pen may be used as touch tips, whereby the user does not need to pay attention to which end he uses for touching.

Below an exemplary embodiment of the invention will be described in detail with reference to the accompanying drawings.

### BRIEF DESCRIPTION OF THE DRAWINGS

FIG. 1 shows a side view of the combined touch pen in an inserted form,

FIG. 2 shows the touch pen comprising two parts which are shown pulled apart so that the touch pen part and a support leg part are separated,

FIG. 3 shows the support leg part extended by partial pulling apart its telescopic elements,

FIG. 4 shows the combined touch pen again with the parts inserted into one another wherein however the support leg part is inserted into the touch pen part in an orientation reversed, with respect to the way it is shown in FIG. 1,

FIG. 5 shows a longitudinal sectional view of a slightly modified embodiment of the touch pen in am assembled state,

FIG. 6 shows the touch pen according to FIG. 5 in a longitudinal cross-sectional view inserted into one another but in a reversed orientation of the support leg part,

FIG. 7 shows a representation similar to FIG. 6 wherein however the pivotally connected plug part of the support leg part is angled, and

FIG. 8 shows a representation similar to FIG. 7 wherein the support leg part is telescopically extended.

### DESCRIPTION OF EXEMPLARY EMBODIMENTS

FIG. 1 shows the combined touch pen according to the invention in an inserted state as a uniform body. It consists of a touch pen part 1, and a support leg part 2. In FIG. 1, one part is inserted into the other.

FIG. 2 shows the touch pen part 1 and the support leg part 2 pulled apart that is separated.

The touch pen part 1 is of a sleeve-like design and has at its front end a cap-like soft touch tip 11.

The support leg part 2 is provided at its front end with a plug 22 which is connected to the other support leg part by a hinge joint. The plug 22 is sized and shaped in such a way that it can be inserted into the earphone socket of a smart phone. At the opposite, that is the rear end, the support leg part is provided with a slip-r of the touch pen part so that it can be used as slide resistant foot as well as a second touch tip, when the touch pen is in the inserted state as shown in FIG. 1.

FIG. 3 shows the telescope-like constructed support leg part 2 partially extended and, thereby, elongated.

From this representation, it can be seen that the support leg part body consists of two telescopic elements 24 and 25 which can be inserted into one another or extended. They are frictionally engaged with one another so that a certain force is needed to move them relative to each other.

The rear part of the support leg part is provided at its circumference with several grooves in which rubber rings 26 are accommodated which project slightly from circumferential surface so that, upon insertion of the support leg part into the touch pen part, the rubber rings engage the inner sleeve wall surface of the touch pen part 1 to provide for an elastic but firm engagement support.

For the insertion of the support leg part into the touch pen part, the support leg part is inserted into the sleeve of the touch pen part 1 with the plug 22 being in front. The sleeve body of the touch pen part 1 is not completely closed at its front end which is provided with the touch tip 11 but has a central bore through which the air can escape when the support leg part 2 is inserted into the sleeve body of the touch pen part 1. Accordingly, also the touch tip 11 of the touch pen part 1 has a small central opening to permit the air to escape. Instead of one central opening, also a number of about radially opening passages may be provided on the touch tip. Alternatively, also the touch tip 11 may be formed without vent opening and the sleeve body of the touch pen 1 may have at least one radial venting bore.

FIG. 4 shows the support leg part 2 inserted into the touch pen part 1 oriented in a reversed way with regard to the orientation shown in FIG. 1 so that the plug 22 projects freely and the so-assembled arrangement may be used as a support leg.

FIGS. 5 to 8 show a slightly modified embodiment of the combined touch pen according to the invention wherein the representations according to FIGS. 5 to 8 are cross-sectional views. Heroin, FIG. 5 shows the touch pen with the parts inserted into one another similar to FIG. 1 wherein the plug 22 is in the sleeve of the touch pen part 1, and FIG. 6 shows the arrangement according to FIG. 4 where the support leg part is oriented reversed, so that the plug 22 projects from the sleeve of the touch pen part 1.

The difference between the embodiments of FIGS. 5-8 with respect to the embodiment according to FIGS. 1-4 resides in the fact that the telescopic arrangement of the support leg part is so configured that, in the insertion state of the telescopic arrangement as it is shown in FIGS. 6 and 7, the end area of the telescopic element 25 which is provided with hinge 21 for the connection of the plug 22 projects from the telescopic element so that the plug 22 is pivotable as shown in FIG. 7.

While FIG. 7 shows the retracted telescopic state of the support leg part. FIG. 8 shows the extended telescopic state of the support leg part.

The embodiment, according to FIGS. 1-4 has the advantage that the overall length of the combined touch pen in a retracted state is shorter than the embodiment according to FIGS. 5-8. However, the embodiment according to FIGS. 5-8 has the advantage over the embodiment according to FIGS. 1-4 that the plug 22 is always pivotable without extending the telescopic parts.

What is claimed is:

1. A combined touch pen for touching touch-sensitive screens of smart phones or similar apparatus, comprising a touch pen part (1) and a support leg part (2), the touch pen part (1) being provided at its front end with a touch tip (11), the support leg part being provided at its end with a plug (22) which is connected to the support leg part by a pivot hinge (21) and which is insertable into an ear phone socket of the smart phone or into another opening thereof, and the touch pen part (1) and the support leg part (2) being releasably assembled to a uniform body in that one (1) of these two parts (1, 2) is in the form of a sleeve-body in which the other part (2) can be at least partially accommodated.

2. The touch pen according to claim 1, wherein the touch pen part (1) is provided with a sleeve body and the support leg part (2) is insertable into this sleeve body.

3. The touch pen according to claim 2, wherein the support leg part (2) is insertable into the sleeve body of the touch pen part (1) with the plug (22) entering first.

4. The touch pen according to claim 2, wherein the support leg part (2) is selectively insertable into the sleeve body (1) with the plug (22) entering first or in a reversed orientation.

5. The touch pen according to claim 1, wherein the support leg part (2) is provided, at its end opposite the plug (22), with a slip-resistant foot element (23).

6. The touch pen according to claim 5, wherein the foot element (23) is in the form of a second touch tip which is selectively usable when the support leg part (2) is inserted into the touch pen part (1).

7. The touch pen according to one of claims 1 to 6, wherein the support leg part (2) is provided with two telescopic slide elements (24, 25) for length adjustment thereof.

8. The couch pen according to claim 7, wherein the telescopic slide elements (24, 25) are frictionally engaged for maintaining their relative adjustment positions.

9. The touch pen according to claim 7, wherein at least one of the sleeve body of the touch pen part (1) and the touch tip (11) is provided with a vent bore for venting the interior of the sleeve body during insertion of the support leg part (2).

10. The touch pen according to claim 7, wherein the inner telescopic element (25) is connected to the plug (22) via the hinge joint (21) and the telescope arrangement is so configured that the hinge joint (21) projects from the outer telescopic element (24) to permit pivoting of the plug (22) when the inner telescopic element (25) is completely inserted into the outer telescopic element (24).

11. The touch pen according to claim 1, wherein the support leg part (2) to foe accommodated in the sleeve body of the touch pen part (1) is provided at its circumferential surface area cooperating with the inner wall surface of the sleeve body with rubber rings (26), rubber-like material or other elastic material which is received in, and slightly projects from, the surface of the support leg part (2).
